(19) United States
(12) Patent Application Publication
(10) Pub. No.: US 2011/0236152 A1
(43) Pub. Date: Sep. 29, 2011

(54) TRANSPORTATION PLATFORM AND THE COMBINATION THEREOF

(76) Inventors: Xinlin Lu, Jiangsu (CN); Xiong Zhao, Jiangsu (CN); Xuri Chen, Jiangsu (CN); Yao Chen, Jiangsu (CN)

(21) Appl. No.: 13/132,282

(22) PCT Filed: Dec. 16, 2009
(86) PCT No.: PCT/CN09/01464

§ 371 Date: Jun. 1, 2011

(30) Foreign Application Priority Data
Dec. 16, 2008 (CN) 2008 10239737.3
Dec. 16, 2008 (CN) 200820124654.5

(51) Int. Cl. B63B 25/22; B60P 1/64; B63B 25/00

(52) U.S. Cl. 410/71

(57) ABSTRACT

A transportation platform is provided for using in the stern berth of a container ship to stack nonstandard containers/combined containers. The transportation platform includes a frame with a width corresponding to the ISO standard container width, at least one fixing corner fitting group arranged on the bottom surface of the frame, in which each fixing corner fitting group includes four bottom corner fittings which are arranged according to the corner fitting arrangement for the ISO standard containers, a plurality of top corner fittings arranged on the top surface of the frame, which can be combined into at least one stacking corner fitting group, each stacking corner fitting group has four 2×2 arrayed top corner fittings with a predefined space between each other in length direction, corresponding to the corner fitting space in length direction for the stacked nonstandard containers or combined containers.

### FIELD OF THE INVENTION

The present invention relates to a transportation platform, in particular to a transportation platform for transporting containers with special length size by means of the berths at ship's stern. The invention also relates to a combination of said transportation platforms.

### BACKGROUND OF THE INVENTION

At present, in the transportation of containers by use of container ships, usually two colligation bridges 2 are arranged both in front and in rear part on the deck 1 of the stern of a container ship, as shown in FIG. 1, and usually a capstan (not shown) for ship mooring between the two colligation bridges 2 is arranged, so a space 8 with a certain height should be set aside at the stern up from the deck for stacking containers. Therefore, usually a high stage 3 with a certain height above the deck 1 is arranged at the stern for installing the capstan in the space 8. In addition, corner fixing modules 4 or 5 on the high stage 3 are used to define a plurality of stern berths with at least one group of corner fixing modules in each stern berth, and each group of corner fixing modules is composed of a plurality of (e.g. four) corner fitting seas 4 or 5, and has a first length size and a first width size corresponding to the ISO standard container sizes. For example, the four corner fixing modules 4 can be arranged with a 40′ ISO standard container corner fitting space to define a berth for stacking the 40′ ISO standard container berths, while the four corner fixing modules 5 can be arranged with a 45′ ISO standard container corner fitting space to define a berth for stacking the 45′ ISO standard container berths,

However, since the above corner fixing modules 4,5 correspond to the standard container's sizes, it is impossible to transport other containers with nonstandard sizes, even those with a standard width size but a nonstandard length size, resulting thus in a very low efficiency in use of the stern berth even though the ship is fully loaded.

### SUMMARY OF THE INVENTION

It is one objective of the invention to provide a transportation platform to solve one or more drawbacks of the prior art.

To realize the above objective, the invention provides a transportation platform for the use in the stern berth of a container ship to stack nonstandard containers/combined containers. Said combined containers are composed of a plurality of containers arranged in length direction, in which at least one corner fixing module group for stacking standard containers is arranged in each stern berth, and each corner fixing module group includes four corner fixing modules which are arranged according to the corner fitting arrangement for the ISO standard containers. Said transportation platform comprises a frame with a width corresponding to the ISO standard container width, at least one fixing corner fitting group arranged on the bottom surface of said frame, in which each fixing includes four bottom corner fittings which are arranged according to the corner fitting arrangement for the ISO standard containers, a plurality of top corner fittings arranged on the top surface of said frame, which can be combined into at least one stacking corner fitting group, each stacking corner fitting group includes four 2×2 arrayed top corner fittings with a predefined space between each other in length direction, corresponding to the corner fitting space in length direction for the stacked nonstandard containers or combined containers.

Furthermore, said frame includes a pair of longitudinal beams arranged in parallel, said corner fitting is arranged on said longitudinal beam, and at least one pair of end beams connected between said a pair of longitudinal beams, respectively.

Furthermore, said frame includes one or more intermediate beams located between said at least one pair of end beams and are thereto, both end of each intermediate beam are connected to said longitudinal beams, and the space between at least one intermediate transverse beam and one end beam is set to correspond to the length direction size of the stacked nonstandard length container or combined container.

Furthermore, said a plurality of top corner fittings are arranged to be a plurality of arrays in said frame's length direction, said a plurality of arrays include two outer side arrays in the outer side of said frame and at least one intermediate array between the two outer side arrays, the top corner fittings of each outer side array are arranged on a relevant longitudinal beam, while the top corner fittings of said intermediate array are arranged on the end beam and/or intermediate beam.

Furthermore, said stacking corner fitting group is composed of two top corner fittings on one outer side array and two relevant top corner fittings of the other outer side array, and has a space size in a predefined width direction, corresponding to the corner fitting space in width direction of the stacked nonstandard container/combined container.

Furthermore, said stacking corner fitting group is composed of two top corner fittings in a outer side array and two top corner fittings in an intermediate array, and has a space in a predefined width direction, said space in the redefined width direction correspond to the corner fitting space of the stacked nonstandard containers/combined containers in the width direction.

Furthermore, a fixed corner fitting group is arranged on said transportation platform, the four corner fittings of said fixed corner fitting group are arranged to an array according to the corner fitting arrangement for the 40′ or 45′ ISO standard containers.

Furthermore, two fixed corner fitting groups are arranged on said transportation platform, the four corner fittings of one fixed corner fitting group are arranged to an array according to the corner fitting arrangement for the 40′ ISO standard containers, while the four corner fittings of the other fixed corner fitting group are arranged to an array according to the corner fitting arrangement for the 45′ ISO standard containers.

Said nonstandard containers are the containers with a length of 24′, 30′, 45′, 48′, 53′, 7450 mm, or 7820 mm respectively. Said combined containers are combined containers with 30′+10′, 24′+24′, 7450 mm+7450 mm, or 7820 mm+7820 mm in length.

Furthermore, the bottom corner fittings of said transportation platform are connected with the corner fittings in relevant stern berth or on standard containers through twist lock, while their top corner fittings are connected with the corner fittings on relevant nonstandard containers or on combined containers through twist lock.

It is another objective of the invention to provide a combination of transportation platform.

The objective of the invention is realized by providing a combination of transportation platforms for the use on the stern berth of a container ship to stack nonstandard containers/combined containers. Said combined container is formed by combining a plurality of containers in length direction, in which at least one corner fixing module group for stacking standard containers is arranged in each stern berth, each corner fixing module group comprises four corner fixing modules arrayed according to the corner fitting arrangement for ISO standard containers. Said transportation platform combination is formed by arraying in parallel a plurality of transportation platforms in width direction, each transportation platform comprises a frame having a frame width corresponding to an ISO standard container's width, at least one fixed corner fitting group arranged on the bottom surface of said frame, each fixed corner fitting group comprising four bottom corner fittings arrayed according to the corner fitting arrangement of an ISO standard container, and a plurality of top corner fittings arranged on the top surface of said frame, which can be combined into at least one stacking corner fitting group, each stacking corner fitting group comprising four 2×2 arrayed top corner fittings, and having a predefined space in length direction, which correspond to the corner fitting space of the stacked nonstandard containers or combined containers in length direction.

Furthermore, two top corner fittings in the intermediate row of one transportation platform and two top corner fittings in outer side row of the other transportation platform form together a strided stacking corner fitting group with a predefined space size in width direction, corresponding to the corner fitting in width direction of the stacked nonstandard container or the combined container.

Furthermore, two top corner fittings in the intermediate row of one transportation platform and two top corner fittings in the intermediate row of the other adjacent transportation platform form together another strided stacking corner fitting group with a predefined space size in width direction, corresponding to the corner fitting in width direction of the stacked nonstandard container or the combined container.

Again, according to the present invention, a plurality of sets of transportation platform can be combined as a whole set for use, and containers with special length size can be also restraint, stacked and transported as convenient as the standard containers during the transportation. Again, the 40′/45′ standard containers can be normally transported without any difficulty. The space of stern berth can be fully used, so that the transportation costs can be reduced. The upper space can be fully used for multi-layer stacked containers to improve the utility of stern berth, reduce the cost, so as to solve the difficulty in the transportation (especially the ISO sea transportation) of different containers with special length sizes.

The present invention will now be described in details with the drawings and embodiments, which, however, won't be considered as the limit to the invention.

### BRIEF DESCRIPTION OF THE DRAWINGS

FIG. 1 is a longitudinal sectional view showing a stern berth of a container ship according to the present invention.

FIG. 2A is a front view showing the transportation platform according to the invention.

FIG. 2B is a top view showing the transportation platform according to the present invention, in which intermediate top corner fittings are arranged between the two longitudinal beams of the frame.

FIG. 3 is a side perspective view showing the side part of the transportation platform stacked with combined containers of special length size according to the present invention.

FIG. 4 is a side perspective view showing the stacking of a single container with special length size on the transportation platform according to the present invention.

FIG. 5 is an end perspective view showing the stacking of the containers with special length but with standard width size on the transportation platform according to the present invention.

FIG. 6 is an end view showing the stacking of the containers with extra large width size on the transportation platform according to the present invention.

FIG. 7 is a side perspective view showing stacking of a transportation platform according to the present invention on standard containers on which the combined containers with special length size are further stacked.

FIG. 8 is a side perspective view showing the stacking of a transportation platform according to the present invention on standard containers on which a single container with special length size are further stacked.

FIG. 9 is an end perspective view showing the stacking of a transportation platform according to the present invention on standard containers on which the containers with special but with standard width size are further stacked.

FIG. 10 is an end perspective view showing the stacking of a transportation platform according to the present invention on standard containers on which the combined containers with extra large width size are further stacked.

### DETAILED DESCRIPTION OF THE PREFERRED EMBODIMENT

The present invention will now be described through illustrative embodiments. It should be noted that, in the case of no further description, any components, structures and features described in one embodiment can also be beneficially incorporated into other embodiments.

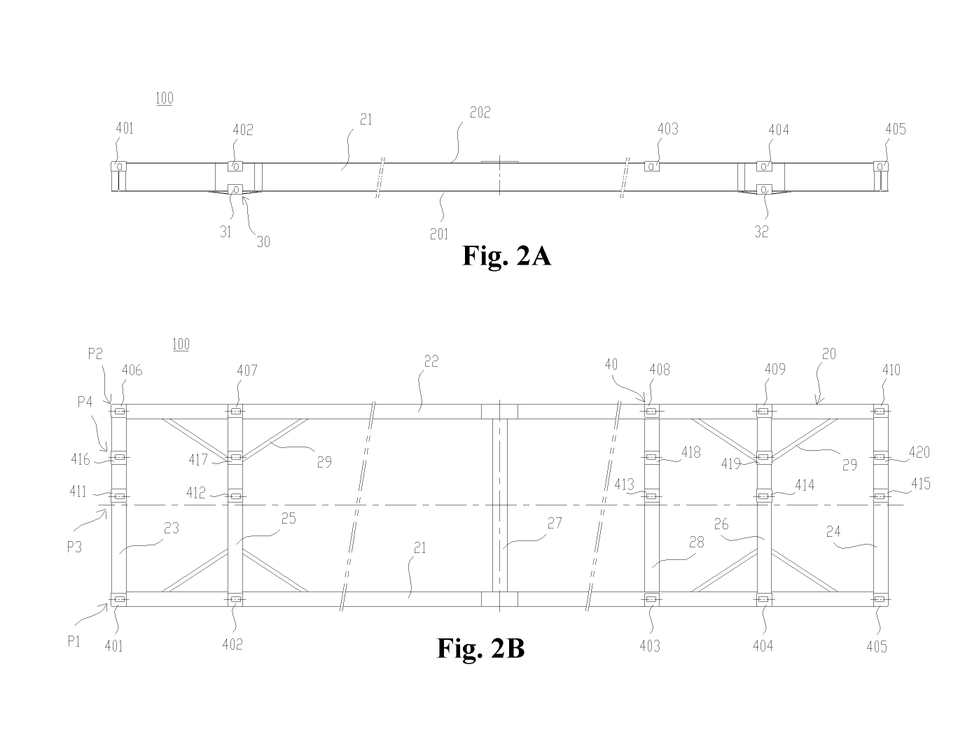

A structure of a transportation platform according to the invention is shown in FIGS. 2A and 2B. The transportation platform 100 comprises a frame 20, a plurality of bottom corner fittings 31 and 32 arranged on the bottom surface 201 of said frame 20, and a plurality of top corner fittings 401˜420 arranged on the top surface 202 of said frame 20.

The frame 20 of the transportation platform according to the invention can be composed of a pair of parallel longitudinal beams. Of course, said frame 20 can also comprise a fixed beam 27 for connecting and fixing said a pair of longitudinal beams 21, 22; preferably, it can further comprise a pair of end beams 23, 24 located on outer side and a pair of end beams 25, 26 located on inner side, said end beams 23,24,25,26 are located between a pair of longitudinal beams 21,22 and are connected with said end beams 21,22 at their ends. According to the present invention, said frame 20 can further comprise at least an intermediate beam, such as the intermediate beam 28 in FIG. 2B, which is located between an end beams 25,26 and are parallel thereto, and both ends are connected to said a pair of longitudinal beams 21,22, respectively. Set the position of said intermediate beam 28 to make its space with one of the end beam correspond to the length size of a container with nonstandard length to enable the transportation of containers with nonstandard length, e.g., the space between the end beam 25 and the intermediate transverse beam 28 is set to correspond to the length size of a container/combined container with nonstandard length. The frame 20 has a frame length and a frame width, said frame length can be the length of said longitudinal beam 21, 22, and is designed to correspond to the length of a stacked single container or combined container; said frame width can be designed to correspond to the width of an ISO standard container. Said combined container is formed by connecting a plurality of containers in length direction.

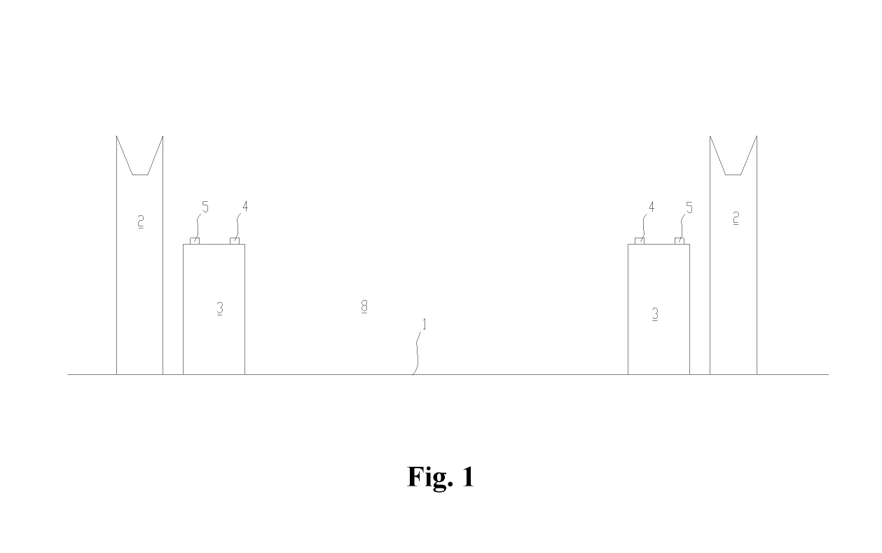

A plurality of bottom corner fittings 31, 32 can be combined into at least one fixing corner fitting group. Each fixing corner fitting group comprises four corner fittings arranged with a corner fitting space of ISO standard container, i.e., with a second length direction size and a second width direction size corresponding to the ISO standard container size, so that it can be fitted to the corner fitting bottom seat group on the stern berth in FIG. 1 or of the ISO standard container. As is shown in FIG. 2A, the four bottom corner fittings 31,32 on the transportation platform 100 can be arranged according to the ISO 668 standard to form a fixed corner fitting group arranged with an corner fitting space according to the 40′ ISO standard container, so that the corner fittings 31,32 can be fitted and connected with the corner fixing module 4 through twist lock, or fitted and connected with the top corner fitting of the 40′ standard container through twist lock, realizing thus a convenient stack, restraint and transportation. Of course, the size in length direction and the size in width direction of said fixed corner fitting group can also be set according to the standard of the 45′ ISO container. In addition, said fixed corner fitting group is not limited to the group shown in FIG. 2A, it can be also arranged to be two groups or more, such as two groups of 40′ berth and 45′ berth simultaneously, which, of course, won't be considered as the limitation to the present invention.

In another embodiment of the invention, when both the 40′-berth and the 45′-berth corner fitting groups are arranged on the stern berth, two pairs of end beams can be arranged on the frame 20, in which the space of the one pair of end beams 23,24 located on outer side can be set to correspond to the length size of the 45′ ISO standard container or the container/combined container with nonstandard lengths, while the space of the other pair of end beams 25,26 located on inner side can be set to correspond to the length size of the 40′ ISO standard container. In another embodiment of the present invention, when only the 40′-berth or the 45′-berth corner fixing module groups are arranged on stern berth, only one pair of inner side end beams 25, 26 or only one pair of outer side end beams 23,24 can be arranged on the fame 20 accordingly, which, however, won't be used as a limitation to the present invention.

A plurality of top corner fittings 401˜420 can be arranged in rows at suitable locations on the top of the longitudinal beams 21,22, the end beams 23,24,25,26 and the intermediate beam 28 of the frame. For example, they can be designed to be four rows in FIG. 2B, comprising an outer side row P1 composed of the top corner fittings 401˜405 on one outer side of the frame, an outer side row P2 composed of the top corner fittings 406˜410 on the other outer side of the frame, an intermediate row P3 composed of the top corner fittings 411˜415 on the middle position of the frame, and an intermediate row P4 composed of the top corner fittings 416˜420 on the other middle position of the frame. These top corner fittings are arranged to be able to combine freely into at least one stacking corner fitting group, each stacking corner fitting group comprises four 2×2 arrayed top corner fittings, which have a predefined space size in length direction corresponding to the corner fitting space in length direction of a single container or combined container. For example, the top corner fittings 401,404,406,409 can form one group, or the top corner fittings 402,403,407,408 can form one group, or the top corner fittings 401,405,406,410 can form one group, or the top corner fittings 401,403,416,418 can form one group, etc. These stacking corner fitting groups are connected with the relevant single container or combined container through a semiautomatic/automatic twist lock. Said single container can be a container with a standard length, or a container with a special length size, such as the container of a length of 24′, 30′, 45′, 48′, 53′, 7450 mm or 7820 mm Said combined container can be formed by connecting two containers with the same length or with different lengths, such as a 30′+10′ combined container, a 24′+24′ combined container, a 7450 mm+7450 mm combined container or a 7820 mm+7820 mm combined container, etc.

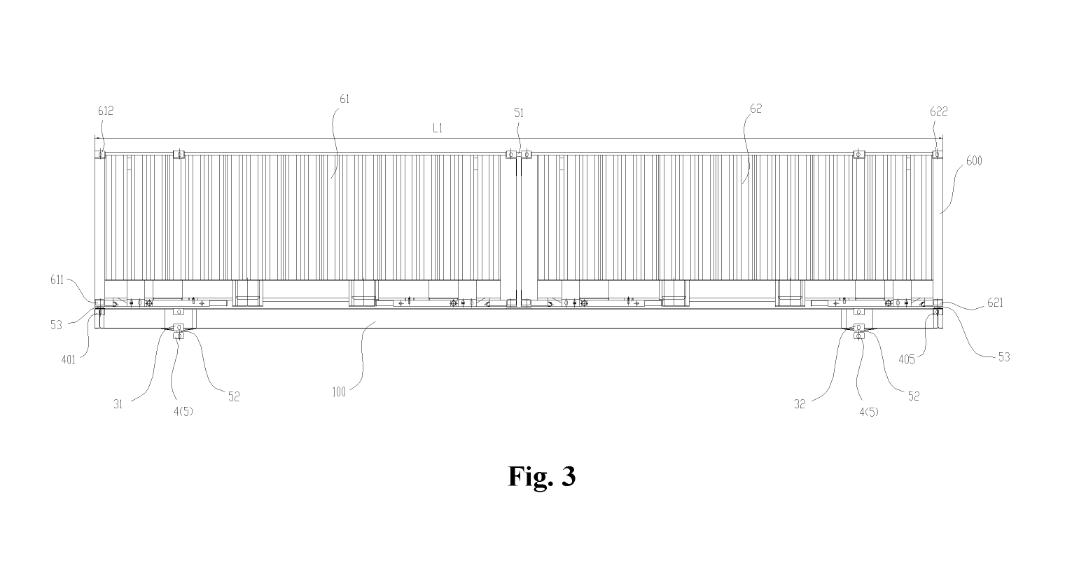

FIG. 3 is a side perspective view showing the combined containers with special lengths stacked by use of the transportation platform according to the first embodiment of the present invention. In the first embodiment, the combined container 600 with a special length L1 is formed by connecting two containers 61, 62. The corner fittings 31, 32 of the transportation platform 100 are locked with the corner fixing module 4 (or 5) through a twist lock 52. The top corner fittings 401, 405 at both ends of the transportation platform can be locked with the bottom corner fitting 611 of the container 61 and the bottom corner fitting 621 of the container 62, so that the transportation platform 100 can be placed directly at the stern berth to transport the combined container 600 with special length size.

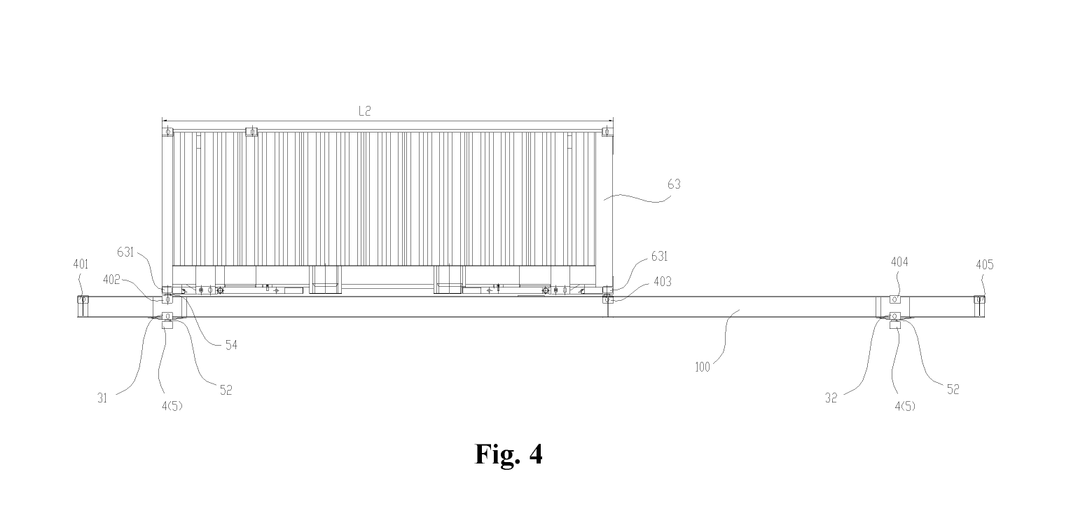

FIG. 4 is a side perspective view showing the containers with special lengths stacked by use of the transportation platform according to the second embodiment of the present invention. In the second embodiment, the bottom corner fittings 31, 32 are locked with the corner fixing module 4 (or 5) through a twist lock 52. The top corner fittings 402,403 are locked with the bottom corner fitting 631 of a single container 63 with a special length size L2 through a twist lock 54, said container can be for example a container of 24′, 30′, 7450 mm or 7820 mm

Using the transportation platform according to the present invention, it is possible to take full use of the stern berth. When there is enough space in the length direction of the stern berth, it is possible to solve the difficulty in transportation of a single container or combined container with nonstandard length size to improve the utility of the stern berth.

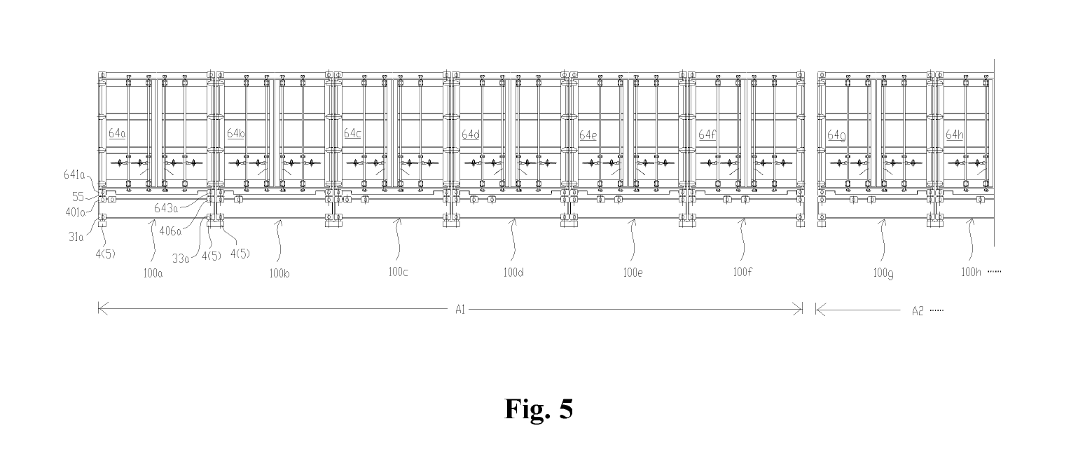

FIG. 5 is an end view showing the stacking of standard containers with special length size by use of transportation platform according to a third embodiment of the present invention. In said third embodiment, combined with FIG. 3, the stern deck can be divided into a plurality of areas, such as the area A1, A2, . . . , each area includes a plurality of stern berths. The two adjacent stern berths in the same area have a relatively small space, while the two adjacent stern berths in two areas have a larger space therebetween. As the width of each stern berth correspond to the width of the ISO standard container, it is possible to design the transportation platform such that it has a predefined width corresponding to the width of the ISO standard container. By use of the combination of a plurality of transportation platform, it is possible to transport a plurality of containers with special length but standard width sizes. For example, in FIG. 5, a plurality of transportation platforms 100a˜100h are placed at the stern berths, while a plurality of containers with standard widths 64a˜64h are stacked on these transportation platform n100a˜100h, respectively. Taking the transportation platform 100a as an example, the bottom corner fittings 31a,33a of the transportation platform 100a are locked with the relevant bottom angle seat 4 (5) through a twist lock, while the top corner fittings 401a, 406a of the transportation platform 100a can be locked with the bottom corner fittings 641a, 643a of the container 64a through the twist lock 55.

In the embodiment of FIGS. 4 and 5, according to the length size of the container body, by adjusting the position of the intermediate beam or the end beam on the transportation platform, it is possible to stack the containers with special length sizes on the transportation platform. Therefore, the present invention suits to be used for nonstandard containers with any length sizes and can take fully use of the upper space.

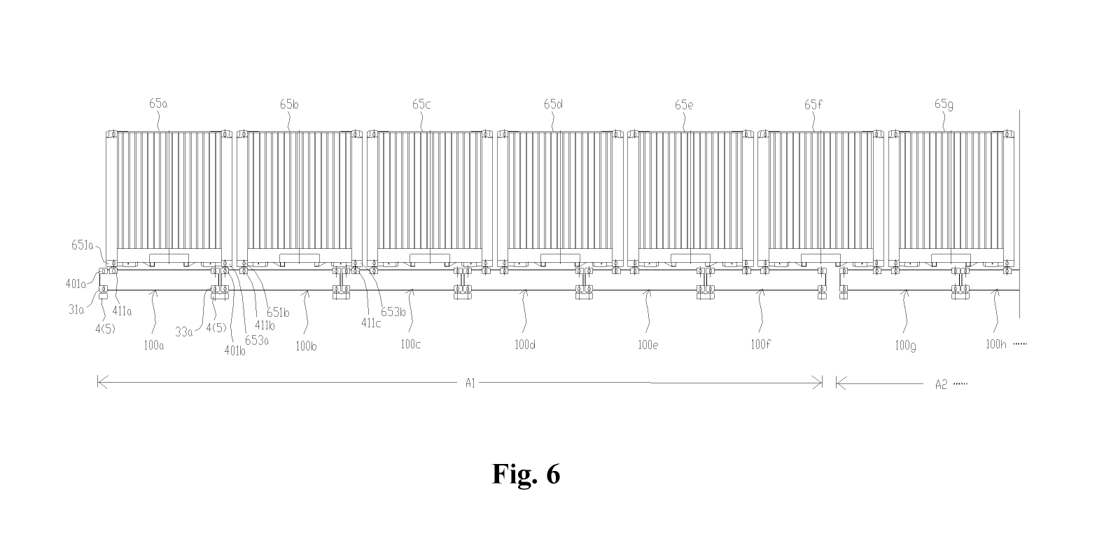

Again, the transportation platforms according to the present invention can be used in various combinations, so that a plurality of containers/combined containers with different width sizes can be stacked in parallel, so as to realize an economic transportation. FIG. 6 is an end view showing the stacking of the containers with extra large width by use of the transportation platform according to the fourth embodiment of the present invention, which has a difference from the third embodiment in that the container in this embodiment is a nonstandard container with an extra large width. To transport these containers with extra large widths 65a˜65g, transportation platforms 100a˜100h are placed at each berth. Referring now to FIG. 2B, these transportation platforms 100a˜100h have not only the outer side top corner fittings but also the intermediate top corner fittings, so that one row of top corner fittings on one transportation platform, together with one row of top corner fittings on another transportation platform at the adjacent berth, can form a striding stacking corner fitting group, the space size in width direction of said striding stacking corner fitting group correspond to the corner fitting space of the stacked container with extra large width in width direction.

Taking the stacking of the container with extra large width 65a as an example, the transportation platform 100a is fixed on the corner fixing module 4 (5) of a berth, while the other adjacent transportation platform 100b is placed on the adjacent berth. The bottom corner fitting 651a of the container with extra large width 65a can be fitted and locked with the top corner fitting 411a of the intermediate row, while the bottom corner fitting 653a of the container with extra large width 65a can be fitted and locked with the top corner fitting 401b of the outer side row on the adjacent transportation platform 100b, thus realizing a stacking of the container with extra large width 65a. Accordingly, the container with extra large width 65b which is adjacent to the container with extra large width 65a can form a striding stacking corner fitting group by use of the top corner fitting 411b of the intermediate row of the transportation platform 100b and the top corner fitting 411c of the intermediate row of the other adjacent transportation platform 100c to realize a stacking of the containers with extra large width 65b, for example, the bottom corner fittings 651b,653b can be fitted and locked with the top corner fittings 411b,411c, respectively.

According to the present invention, an ISO standard container can be firstly stacked on the stern berth, then the transportation platform 100 can be placed on said ISO standard container, and the containers with special length size are stacked on each platform, thus realizing the transportation of the containers with special length sizes.

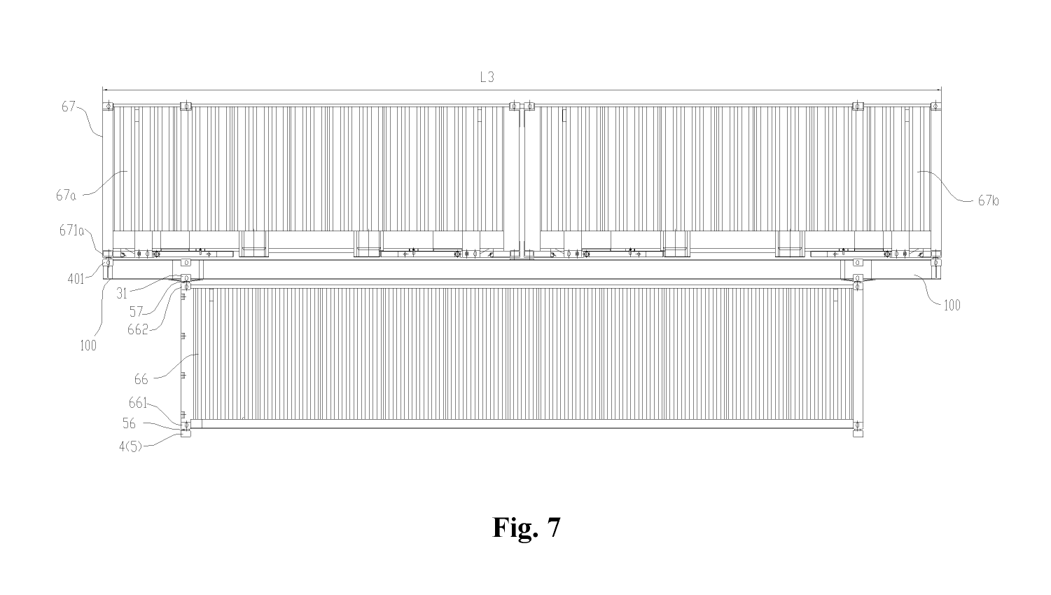

FIG. 7 is a side perspective view showing the stacking of a transportation platform on an ISO standard container and stacking further the combined containers with special length size on said transportation platform according to the fifth embodiment of the present invention. The containers 67a, 67b are connected into a combined container 67. Take its one side as an example to illustrate the stacking relationship among the standard container 66, the transportation platform 100, and the combined container 67. The bottom corner fitting 661 of the standard container 66 is locked with the angle seat 4 (5)through a twist lock, while its top corner fitting 662 is locked with the standard fixed top corner fitting 31 through the twist lock 57 so as to place the transportation platform 100 onto the standard container 66. The top corner fitting (e.g. 401) of the transportation platform 100 can be locked with the bottom corner fitting 671a of the container 67a in the combined container 67 through a twist lock.

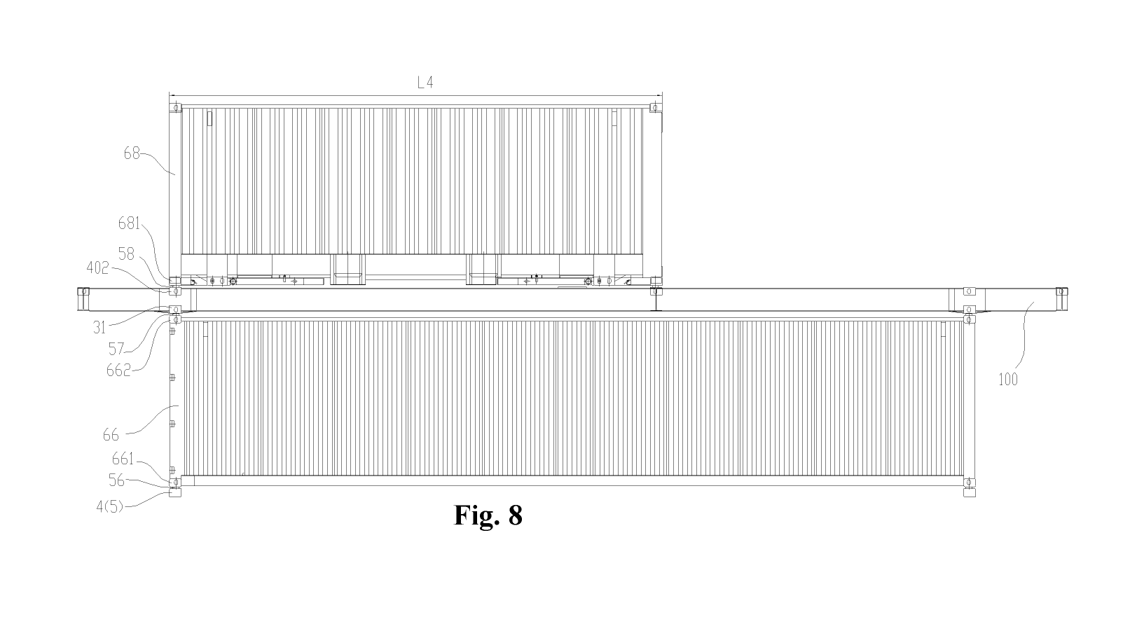

FIG. 8 is a side perspective view showing the stacking of a transportation platform on an ISO standard container and stacking further a single container with special length size on said transportation platform according to the sixth embodiment of the present invention. The container 68 with special length size 68 can be for example a 24′, 30′, 7450 mm or 7820 mm container. Take its one side as an example to illustrate the stacking relationship among the standard container 66, the transportation platform 100, and the container with special length size 68. The bottom corner fitting 661 of the standard container 66 is locked with the corner fixing module 4 (5) through a twist lock, the top corner fitting 662 is locked with the corner fitting 31 on the bottom surface of the transportation platform 100 through a twist lock 57, so that the transportation platform 100 is locked on the standard container 66. The top corner fitting 402 on the top of said transportation platform 100 is locked with the bottom corner fitting 681 of the container 68 through a twist lock.

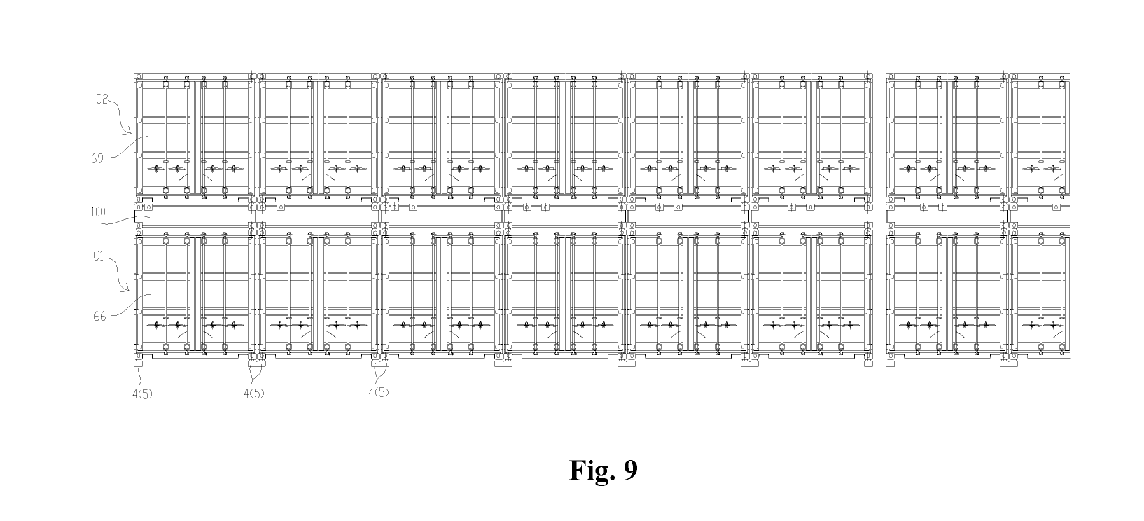

FIG. 9 is an end view showing the stacking of a transportation platform on an ISO standard container and stacking further a container/combined container with special length but with standard width size on said transportation platform according to the seventh embodiment of the present invention. The standard container 66 on the lower layer C1 is fitted with the corner fixing module 4 (5) of the stern berth through its bottom corner fitting to realize the stacking, while the transportation platform 100 is fitted with the top corner fitting of the standard container 66 of the lower layer C1 through its bottom corner fitting on the bottom part and is stacked on said standard container 66 on the lower layer C1. Each of the containers/combined containers 69 with standard width are fitted with the top corner fittings of the corresponding transportation platforms 100 through their bottom corner fittings so as to be stacked on said corresponding transportation platforms 100 respectively.

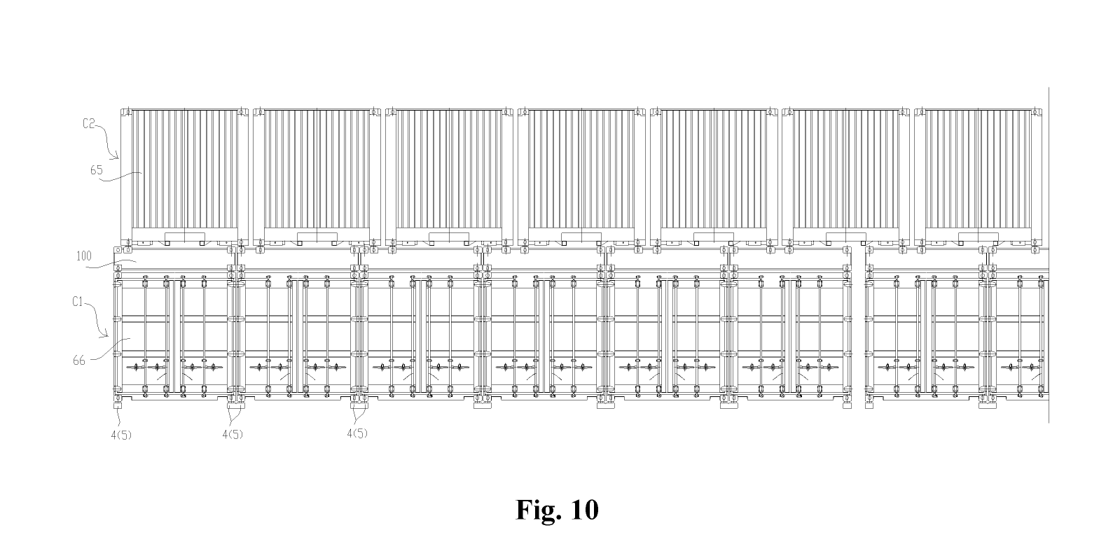

FIG. 10 is an end view showing the stacking of a transportation platform on an ISO standard container and stacking further a container with extra large width on said transportation platform according to the eighth embodiment of the present invention. The standard container 66 on lower layer C1 is fitted with the corner fixing module 4 (5) on the stern berth through its bottom corner fitting to realize a stacking, while the transportation platform 100 is fitted with the top corner fitting of the standard container 66 on the lower layer C1 through its bottom corner fitting so as to stack the transportation platform 100 onto the standard container 66. Each container 65 with extra large width on the upper layer C2 are fitted with the top corner fittings on the top of the corresponding transportation platform 100 through their bottom corner fittings and are stacked on these transportation platforms 100, wherein the stacking method of the container 65 with extra large width 65 is similar to that shown in FIG. 6.

It should be noted that although a description is made to the present invention through the above different embodiments, however, the invention will still have many other embodiments. It will be appreciated by those skilled in the art that changes and modifications may be made thereto without departing from the spirit of the present invention in its broader aspects and as set forth in the following claims.

1. A transportation platform for use in the stern berth of a container ship to stack nonstandard containers/combined containers, in which said combined containers are composed of a plurality of containers arranged lengthwise, comprising:
at least one corner fixing module group for stacking standard containers is arranged in each stern berth;
each corner fixing module group includes four corner fixing modules which are arranged according to the corner fitting arrangement for the ISO standard containers;
a frame with a width corresponding to the ISO standard container width;
at least one fixing corner fitting group arranged on the bottom surface of said frame;
each fixing corner fitting group comprises four bottom corner fittings which are arranged according to the corner fitting arrangement for the ISO standard containers;
a plurality of top corner fittings arranged on the top surface of said frame, which can be combined into at least one stacking corner fitting group, each stacking corner fitting group comprises four 2×2 arrayed top corner fittings with a predefined space between each other in length direction, corresponding to the corner fitting space in length direction for the stacked nonstandard containers or combined containers.

2. The transportation platform according to claim 1, characterized in that said frame further comprises
a pair of longitudinal beams arranged in parallel, said corner fitting is arranged on said longitudinal beam, and
at least one pair of end beams connected between said a pair of longitudinal beams, respectively.

3. The transportation platform according to claim 2, characterized in that said frame further comprises:
one or more intermediate beams located between said at least one pair of end beams and are parallel thereto, both end of each intermediate beam are connected to a pair of said longitudinal beams, and the space between at least one intermediate transverse beam and one end beam is set to correspond to the length direction size of the stacked nonstandard length container or combined container.

4. The transportation platform according to claim 3, characterized in that said a plurality of top corner fittings are arranged to be a plurality of arrays in said frame's length direction, said a plurality of arrays include two outer side arrays in the outer side of said frame and at least one intermediate array between the two outer side arrays, the top corner fittings of each outer side array are arranged respectively on a corresponding longitudinal beam, while the top corner fittings of said intermediate array are arranged on the end beam and/or intermediate beam.

5. The transportation platform according to claim 4, characterized in that said stacking corner fitting group is composed of two top corner fittings on one outer side array and two corresponding top corner fittings of the other outer side array, and has a space size in a predefined width direction corresponding to the corner fitting space in width direction of the stacked nonstandard container/combined container.

6. The transportation platform according to claim 4, characterized in that said stacking corner fitting group is composed of two top corner fittings in a outer side array and two top corner fittings in an intermediate array, and has a space in a predefined width direction, said space in the redefined width direction correspond to the corner fitting space of the stacked nonstandard containers/combined containers in the width direction.

7. The transportation platform according to claim 1, characterized in that a fixed corner fitting group is arranged on said transportation platform, the four corner fittings of said fixed corner fitting group are arranged to array according to the corner fitting arrangement for the 40′ or 45′ ISO standard containers.

8. he transportation platform according to claim 1, characterized in that two fixed corner fitting groups are arranged on said transportation platform, the four corner fittings of one fixed corner fitting group are arranged to array according to the corner fitting arrangement for the 40′ ISO standard containers, while the four corner fittings of the other fixed corner fitting group are arranged to array according to the corner fitting arrangement for the 45′ ISO standard containers.

9. The transportation platform according to claim 1, characterized in that said nonstandard containers are containers with a length of 24′, 30′, 45′, 48′, 53′, 7450 mm, or 7820 mm, said combined containers are combined containers with 30′+10′, 24′+24′, 7450 mm+7450 mm, or 7820 mm+7820 mm in length.

10. The transportation platform according to claim 1, characterized in that the bottom corner fittings of said transportation platform are connected with the corner fittings in corresponding stern berth or on standard containers through twist lock, while their top corner fittings are connected with the corner fittings on corresponding nonstandard containers or on combined containers through twist lock.

11. A combination of transportation platforms for using on the stern berth of a container ship to stack nonstandard containers/combined containers, said combined container is formed by combining a plurality of containers lengthwise, comprising:
at least one corner fixing module group for stacking standard containers is arranged in each stern berth, each corner fixing module group comprises four corner fixing modules arrayed according to the corner fitting arrangement for ISO standard containers;
said transportation platform combination is formed by arraying in parallel a plurality of transportation platforms in width direction according to claim 1, each transportation platform includes
a frame having a frame width corresponding to an ISO standard container's width,
at least one fixed corner fitting group arranged on the bottom surface of said frame, each fixed corner fitting group including four bottom corner fittings arrayed according to the corner fitting arrangement of an ISO standard container, and
a plurality of top corner fittings arranged on the top surface of said frame, which can be combined into at least one stacking corner fitting group, each stacking corner fitting group comprising four 2×2 arrayed top corner fittings, and having a predefined space in length direction, which corresponds to the corner fitting space of the stacked nonstandard containers or combined containers in length direction.

12. The combination of transportation platforms according to claim 11, characterized in that two top corner fittings in the intermediate row of one transportation platform and two top corner fittings in outer side row of the other adjacent transportation platform form together a strided stacking corner fitting group with a predefined space size in width direction, corresponding to the corner fitting in width direction of the stacked nonstandard container or the combined container.

13. The combination of transportation platforms according to claim 11, characterized in that two top corner fittings in the intermediate row of one transportation platform and two top corner fittings in the intermediate row of the other adjacent transportation platform form together another strided stacking corner fitting group with a predefined space size in width direction, corresponding to the corner fitting space in width direction of the stacked nonstandard container or the combined container.

14. The combination of transportation platforms according to claim 12, characterized in that two top corner fittings in the intermediate row of one transportation platform and two top corner fittings in the intermediate row of the other adjacent transportation platform form together another strided stacking corner fitting group with a predefined space size in width direction, corresponding to the corner fitting space in width direction of the stacked nonstandard container or the combined container.
